(19) United States
(12) Patent Application Publication
(10) Pub. No.: US 2019/0386583 A1
(43) Pub. Date: Dec. 19, 2019

(54) VIBRATION WAVE MOTOR AND APPARATUS INCORPORATING SAME

(71) Applicant: CANON KABUSHIKI KAISHA, Tokyo (JP)

(72) Inventor: Akira Shimada, Saitama-shi (JP)

(21) Appl. No.: 16/434,688

(22) Filed: Jun. 7, 2019

(30) Foreign Application Priority Data
Jun. 14, 2018 (JP) 2018-113762

(51) Int. Cl. H02N 2/10; H02N 2/00

(52) U.S. Cl. CPC H02N 2/103; G02B 7/005; H02N 2/0035

(57) ABSTRACT

A vibration wave motor includes a rotational shaft body, an electrical-mechanical energy conversion element, a first elastic body that is fitted into the rotational shaft body and configured to vibrate by the electrical-mechanical energy conversion element, a positioning member configured to position the rotational shaft body in a rotation axis direction of the rotational shaft body, and a connection member configured to connect the first elastic body to the positioning member.

### BACKGROUND OF THE INVENTION

### Field of the Invention

The present disclosure relates to a vibration wave motor and an apparatus incorporating the vibration wave motor.

### Description of the Related Art

In general, vibration wave motors are used for driving of camera lenses and the like. The vibration wave motors include a ring-type vibration wave motor and a rod-type vibration wave motor (hereinafter referred to as a rod-type ultrasonic motor (USM)) are available, for example. The ring-type vibration wave motor uses a ring-shaped vibrator, whereas the rod-type USM uses a rod-shaped vibrator. Examples of the rod-type USMs include a shaft-output-type USM (hereinafter referred to as a shall output USM) and a gear-output-type USM (hereinafter referred to as a gear output USM). The shaft output USM extracts an output from a rotational shaft body that rotates about an axis (makes axial rotation), whereas the gear output USM extracts an output from a gear that makes axial rotation. Japanese Patent Application Laid-Open No. 2000-308375 and Japanese Patent Application Laid-Open No. 2016-13009 respectively discuss a shaft output USM and a gear output USM.

The vibration wave motor, which is the shaft output USM, discussed in Japanese Patent Application Laid-Open No. 2000-308375 includes a rotational shaft body (an output shaft) rotatable about an axis and a configuration for causing the rotational shaft body to make axial rotation (rotation about an axis). The configuration for causing the rotational shaft body to make axial rotation includes an electrical-mechanical energy conversion element (a piezoelectric element) having a cylindrical shape, an elastic body (an amplitude enlargement member), a driven member (a rotary body), and a fixing member (a whirl-stop) that fixes the rotational shaft body and the driven member. Herein, the configuration for causing the rotational shaft body to make axial rotation is present on each of both sides of a virtual cross section in a radial direction of the cylindrical piezoelectric element.

Since the vibration wave motor discussed in Japanese Patent Application Laid-Open No. 2000-308375 includes two configurations for causing the rotation shaft body to make axial rotation, high driving force is generated. However, since the two same configurations are plane-symmetrically arranged, the vibration wave motor is large.

FIG. 7 illustrates the vibration wave motor, which is the gear output USM, discussed in Japanese Patent Application Laid-Open No. 2016-13009.

The gear output USM discussed in Japanese Patent Application Laid-Open No. 2016-13009 includes a stationary shaft 201, a driven member 206 rotatable in a circumferential direction of the stationary shaft 201, and a configuration for causing the driven member 206 to make axial rotation. The configuration for causing the driven member 206 to make axial rotation includes an electrical-mechanical energy conversion element (a piezoelectric element) 202 having a cylindrical shape and an elastic body 203. The driven member 206 is present on only one side of a virtual cross section in a radial direction of the cylindrical piezoelectric element 202.

Since the driven member is present on only one side in the virtual cross section in the radial direction of the cylindrical piezoelectric element 202, the vibration wave motor discussed in Japanese Patent Application Laid-Open No. 2016-13009 has a smaller size. However, in the gear output USM, since an output is transmitted to an external gear by only a spur gear, a degree of freedom of output configuration is low. Accordingly, for example, if the gear output USM is used as a lens drive motor in a camera lens, an optical axis (not illustrated) of a lens and the stationary shaft 201 of the vibration wave motor need to be arranged substantially parallel to each other.

### SUMMARY OF THE INVENTION

The present disclosure has been made in view of such an issue and is to provide a vibration wave motor that achieves not only a smaller size but also a shaft output type, which has a higher degree of freedom of output configuration than a gear output type, and an apparatus incorporating the vibration wave motor.

According to an aspect of the present disclosure, a vibration wave motor includes a rotational shaft body, an electrical-mechanical energy conversion element, a first elastic body that is fitted into the rotational shaft body in an axially rotatable manner and configured to vibrate by the electrical-mechanical energy conversion element, a driven member that is rotated about a rotation axis of the rotational shaft body by vibration of the first elastic body, a fixing member configured to fix the rotational shaft body and the driven member, a positioning member that is fitted into the rotational shaft body in an axially rotatable manner and configured to position the rotational shaft body in a rotation axis direction of the rotational shaft body, and a connection member configured to connect the first elastic body to the positioning member.

Further features of the present disclosure will become apparent from the following description of exemplary embodiments with reference to the attached drawings.

### BRIEF DESCRIPTION OF THE DRAWINGS

FIG. 1 is a perspective diagram illustrating a vibration wave motor according to a first exemplary embodiment.

FIG. 2 is a cross sectional diagram illustrating the vibration wave motor according to the first exemplary embodiment.

FIGS. 3A and 3B are sectional diagrams respectively illustrating a vibrator and a first elastic body according to the first exemplary embodiment,

FIG. 4 is a sectional diagram illustrating a vibration wave motor according to a second exemplary embodiment.

FIG. 5A is a perspective diagram illustrating a vibration wave motor according to a third exemplary embodiment, FIG. 5B is a sectional diagram illustrating the vibration wave motor according to the third exemplary embodiment,

FIG. 6 is a perspective diagram illustrating a digital camera according to a fourth exemplary embodiment.

FIG. 7 is a sectional diagram illustrating an example of a related-art vibration wave motor.

### DESCRIPTION OF THE EMBODIMENTS

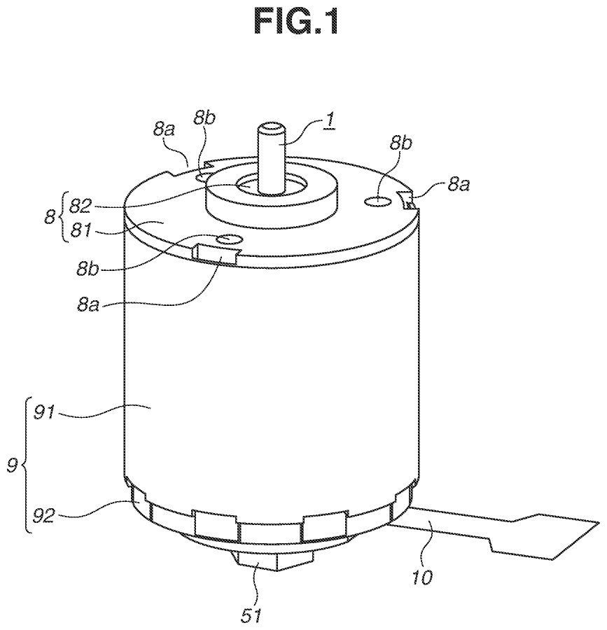

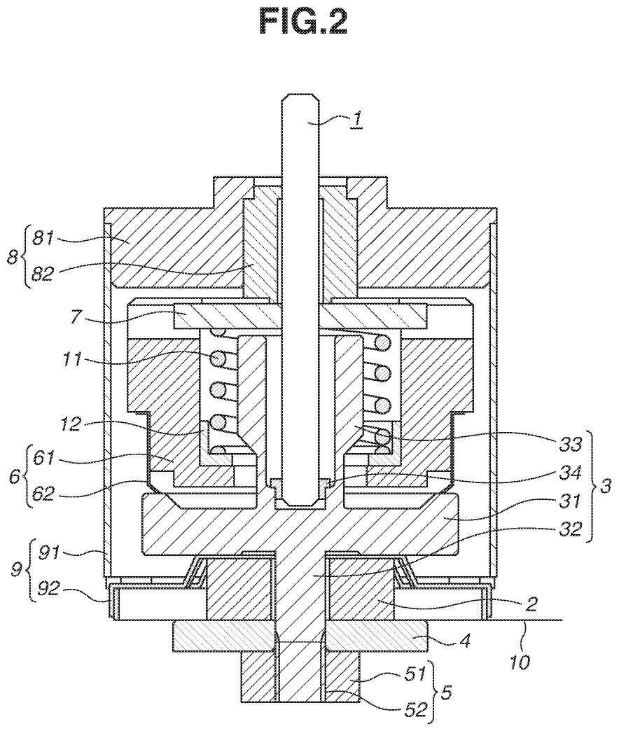

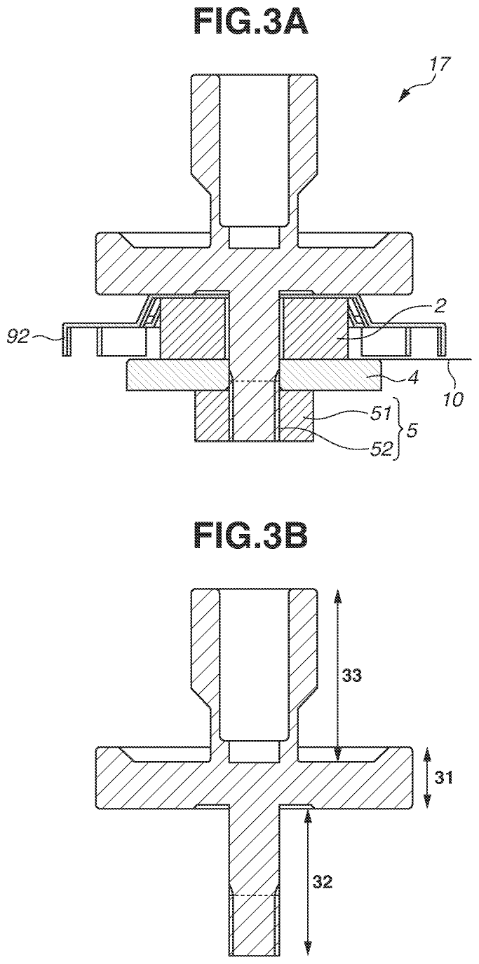

A first exemplary embodiment is described with reference to FIGS. 1 through 3. FIG. 1 is a perspective diagram illustrating a vibration wave motor of the present exemplary embodiment. FIG. 2 is a cross sectional diagram illustrating the vibration wave motor of the present exemplary embodiment. FIGS. 3A and 3B are sectional diagrams respectively illustrating a vibrator and a first elastic body of the vibration wave motor of the present exemplary embodiment.

In FIG. 1, the vibration wave motor includes an output shaft (a rotational shaft body) 1, a nut (a first fastening unit) 51, a positioning member 8, a connection member 9, and a flexible printed board 10.

The positioning member 8 includes a case fixing portion 81 and a second bearing portion 82. The case fixing portion 81 includes a groove 8a and a screw hole 8b. The connection member 9 includes a case (a first connection portion) 91 and a case support portion (a second connection portion) 92.

In FIG. 2, the vibration wave motor includes a piezoelectric element (electrical-mechanical energy conversion element) 2, a first elastic body 3, a second elastic body 4, a fastening member 5, a driven member 6, and a rotation transmission member (fixing member) 7.

The first elastic body 3 includes a first elastic portion 31 and a second elastic portion 32. The first elastic portion 31 has a flange shape the longitudinal direction of which is a direction (a perpendicular direction, a second direction) perpendicular to a longitudinal direction of the rotational shaft body 1 (a rotation axis direction of the rotational shaft body 1, a first direction). The second elastic portion 32 protrudes from a surface (a first surface) piezoelectric element side (an electrical-mechanical energy conversion element side) in the first elastic portion 31, and has a longitudinal direction that is the first direction. The second elastic portion 32 (the first elastic body 3) is fitted into the piezoelectric element 2 and the second elastic body 4. The piezoelectric element 2 is sandwiched between the first elastic portion 31 (the first elastic body 3) and the second elastic body 4. Moreover, the first elastic body 3 includes a first bearing portion 34 and a tube-shaped third elastic portion 33 provided from a surface (a second surface) at a side opposite to the first surface in the first elastic portion 31. A longitudinal direction of the third elastic portion 33 is the first direction. The third elastic portion 33 surrounds the rotational shaft body 1 in the second direction. The third elastic portion 33 and the driven member 6 overlap in the second direction.

In a case where the third elastic portion 33 is shortened in the first direction to make the vibration wave motor smaller in the first direction, a resonance frequency increases. To solve the problem, the third elastic portion 33 and the driven member 6 overlap in the second direction, so that the vibration wave motor becomes smaller in the first direction without a change in a resonance frequency.

The fastening member 5 fastens the piezoelectric element 2 and the second elastic body 4 into which the second elastic portion 32 is fitted to the first elastic portion 31 (the first elastic body 3). The nut 51 and an external thread 52 (described below) formed on the first elastic body 3 (the second elastic portion 32) are used as the fastening member 5. A fastening member is not limited to a nut and an external thread. Another member can be used as long as the piezoelectric element 2 and the second elastic body 4 can be fastened to the first elastic body 3.

The driven member 6 includes a rotor ring (a first driven portion) 61 and a contact portion (a second driven portion) 62, The driven member 6 makes axial rotation about a central axis in the first direction (rotation about a rotation axis of the rotational shaft body 1) by vibration of the first elastic body 3 (the first elastic portion 31) that vibrates by vibration generated from the piezoelectric element 2. The second driven portion 62 has a lower end surface that is in contact with an upper surface of the first elastic body 3 (the first elastic portion 31), The second driven portion 62 is fixed to the first driven portion 61.

The positioning member 8 directly or indirectly positions the rotational shaft body 1 in the first direction. For example, in FIG. 2, the positioning member 8 contacts the fixing member 7 that engages the rotational shaft body 1 to indirectly position the rotational shaft body 1 in the first direction. Alternatively, the positioning member 8 may directly position the rotational shaft body 1 in the first direction while being fitted into the rotational shaft body 1 in such a manner that the rotational shaft body 1 is rotatable about an axis in the first direction.

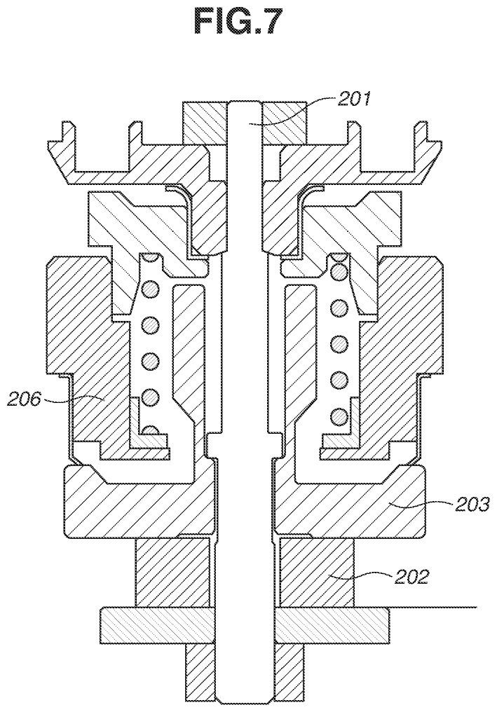

The connection member 9 connects the first elastic body 3 to the positioning member 8. As described below, the connection member 9 can be configured as separate members (described in each of the first and second exemplary embodiments), or as an integrated member (described in a fourth exemplary embodiment). In an example of a conventional vibration wave motor illustrated in FIG. 7, since a stationary shaft 201 does not make axial rotation, a structure of the vibration wave motor is supported by the stationary shall 201. In the present exemplary embodiment, on the other hand, since the rotational shaft body 1 makes axial rotation, a structure of the vibration wave motor cannot be supported by the rotational shaft body 1. Accordingly, the first elastic body 3 and the positioning member 8 are connected by the connection member 9 to support the structure of the vibration wave motor.

In FIG. 2, the protrusion having a cylindrical shape (the second elastic portion 32) is arranged below the first elastic portion 31 so as to penetrate the case support portion 92 having a plate (flange) shape, the piezoelectric element 2, the flexible printed board 10, and the second elastic body 4. On a front end of the second elastic portion 32, the external thread 52 is formed. The case support portion 92, the piezoelectric element 2, the flexible printed board 10, and the second elastic body 4 are fastened with the fastening member 5 including the external thread 52 formed on the first elastic body 3 (the second elastic portion 32) and the nut 51 such that a predetermined holding power is applied. These members form a vibrator 17. In the present exemplary embodiment, the second elastic body 4 and the nut 51 are formed as separate members. However, the second elastic body 4 and the nut 51 can be integrally formed.

For the sake of description, the vibrator 17 and the first elastic body 3 (excluding the first bearing portion 34) of the members forming the vibration wave motor are respectively illustrated in FIGS. 3A and 3B.

The first elastic body 3 is preferably made of a material that has abrasion resistance and shows small attenuation of vibration. Such a material includes martensitic stainless steel. Moreover, the first elastic body 3 is preferably made of a material such as a nitrided material to enhance the abrasion resistance. In the present exemplary embodiment, nitrided martensitic stainless steel is used as a material of the first elastic body 3.

The piezoelectric element 2 includes electrode groups each including two electrodes (phase-A and phase-B piezoelectric elements). If alternating current (AC) electric fields each having different phases are applied to the electrode groups via the flexible printed board 10 from a power source (not illustrated), two bending vibrations perpendicular to each other are excited in the vibrator 17.

The two modes of the vibration have spatial phases around an axial direction, and such spatial phases are shifted by 90 degrees. Accordingly, by adjusting a phase of the applied AC electric field, a temporal phase difference of 90 degrees can be made between the two bending vibrations. As a result, the bending vibration of the vibrator 17 is rotated about an axis, so that an elliptical motion is generated on a contact surface of the first elastic portion 31 contacting the second driven portion 62. Accordingly, a driving force is generated, so that the driven member 6 pressed against the first elastic body 3 is driven.

The piezoelectric element 2 can be a laminated piezoelectric element formed by alternately laminating a plurality of piezoelectric layers and electrode layers while simultaneously burning the laminated layers. Alternatively, the piezoelectric element 2 can have a configuration in which a plurality of single-plate piezoelectric elements is laminated and the laminated single-plate piezoelectric elements are sandwiched between elastic bodies. Further, a sensor-phase electrode is arranged in one portion of the phase-A of the piezoelectric element 2, The sensor-phase electrode creates distortion by the bending vibration of the vibrator 17, generates an electric charge by a positive piezoelectric effect, and detects such an electric charge to monitor a vibration state of the vibrator 17, A phase difference relation between an applied voltage of the phase-A piezoelectric element at this time and an output signal of the sensor-phase electrode is 90 degrees at a resonance frequency. At a frequency higher than the resonance frequency, the phase difference is gradually shifted. Thus, by detecting such a phase difference value when the vibration is being applied, a relation between an input frequency and a resonance frequency of the vibrator 17 can be monitored, so that the vibrator 17 can be stably driven.

In FIG. 2, the second driven portion 62 has a lower end surface that contacts the first elastic portion 31. The second driven portion 62 is fixed to the first driven portion 61, and the first driven portion 61 is rotatable (can make axial rotation) with the second driven portion 62 about the center (the central axis) in the longitudinal direction (the first direction) of the rotational shaft body 1. With the vibration of the first elastic portion 31, the first driven portion 61 and the second driven portion 62 are rotated about the center (the central axis) in the first direction.

The second driven portion 62 preferably has an appropriate spring property to follow the vibration of the vibrator 17. Thus, in the present exemplary embodiment, the second driven portion 62 has such a structure. The second driven portion 62 is preferably made of a material having abrasion resistance, high strength, and corrosion resistance. Although stainless steel is considered as such a material, SUS420J2 is preferable to the stainless steel. In the present exemplary embodiment, SUS420J2 is used as a material constituting the second driven portion 62.

Although lathe work or a three-dimensional printer can be employed as a processing method for the second driven portion 62, press work is preferred from standpoints of processing accuracy and costs. The second driven portion 62 is fixed to the first driven portion 61 by a technique such as attachment using resin adhesive, metal blazing such as soldering, welding such as laser welding and resistance welding, and mechanical bonding such as press-fitting and caulking.

The first driven portion 61 is pressed by a pressing spring (a pressing member) 11 via a rubber ring 12. Such a press generates a friction force between the second driven portion 62 and the first elastic portion 31, and the second driven portion 62 can be rotated by the aforementioned elliptical motion. The rubber ring 12 functions to equalize a pressing force.

The rotation transmission member (fixing member) 7 engages the rotational shaft body 1 and the first driven portion 61 (the driven member 6) (the rotational shaft body 1 and the first driven portion 61 are fixed). The first driven portion 61 has a recessed portion that engages a projecting portion formed on the fixing member 7, which engages the rotational shaft body 1. Thus, the rotational shaft body 1 is rotatable (can make axial rotation) about the center (the central axis) the first direction with the fixing member 7 and the driven member 6. The rotation (axial rotation) of the rotational shaft body 1 transmits an output of the vibration wave motor to the outside.

On the other hand, the fixing member 7 is hindered from moving in a direction (the second direction) perpendicular to the first direction with respect to the first driven portion 61. However, since the fixing member 7 is not hindered from moving in the first direction, the fixing member 7 slides with respect to the second bearing portion 82 while receiving a reaction force of the pressing spring 11, The fixing member 7 engages the rotational shaft body 1 (the fixing member 7 is fixed to the rotational shaft body 1) by press-fitting or attaching, and is rotatable (can make axial rotation) with the rotational shaft body 1, The fixing member 7 is preferably made of a material having abrasion resistance and high strength. Stainless steel is considered to be such a material. In the present exemplary embodiment, stainless steel is used as a material constituting the fixing member 7.

The rotational shaft body 1 is fitted into the first bearing portion 34 described below and the second bearing portion 82, so that the rotational shaft body 1 is rotatable (can make axial rotation) about the center (the central axis) in the first direction, and is hindered from moving in a radial direction (the second direction). The first bearing portion 34 is fixed to the first elastic body 3 by press-fitting or attaching. A position in which the first bearing portion 34 is to be fixed is near a position of a node (including the position of the node) of the vibration in the vibrator 17, thereby minimizing attenuation of the vibration. The rotation of the rotational shaft body 1 can be directly received by the first elastic body 3 without going through a bearing such as the first bearing portion 34. However, the use of a bearing is preferable to prevent propagation of the vibration to the rotational shaft body 1. The bearing is preferably made of resin that has a good effect of preventing vibration propagation to the rotational shaft body 1.

The rotational shaft body 1 can penetrate the second elastic portion 32 in the first direction. However, as described in the present exemplary embodiment, it is preferable that the rotational shaft body 1 does not penetrate the second elastic portion 32 in the first direction, and the rotational shaft body 1 and the piezoelectric element 2 do not overlap in the second direction. Consequently, a diameter of the second elastic portion 32 in the second direction can be reduced, and design flexibility of the first elastic body 3 can be enhanced.

The connection member 9 connects the first elastic body 3 to the positioning member 8. The vibrator 17 is fixed to the tubular case 91 via the case support portion 92. The case support portion 92 has appropriate spring property so as not to inhibit vibration of the vibrator 17. The case 91 is fixed to the positioning member 8. A method for fixing the case 91 to the positioning member 8 can be achieved by attaching or press-fitting. However, in the present exemplary embodiment, the case 91 is caulked along three grooves 8A formed in the positioning member 8 (the case fixing portion 81). Since the caulking has a good workability and is less expensive, the caulking is suitable for fixing of the case 91.

The positioning member 8 (the case fixing portion 81) includes the screw hole 8b for fixation, and is fixed to another member. The second bearing portion 82 is arranged on an inner diameter side of the positioning member 8 (the case fixing portion 81). In the present exemplary embodiment, the case fixing portion 81 and the second bearing portion 82 are formed as separate portions. However, the separate portions can be integrally formed if a material having high strength, abrasion resistance, and low friction coefficient is used.

If a spur gear is arranged at the front end of the rotational shaft body 1, a rotational shaft body of a gear of a driven body (not illustrated) and the rotational shaft body 1 can be arranged parallel to each other. If a worm gear is arranged at the front end of the rotational shaft body 1, a rotational shaft body of a gear of a driven body (not illustrated) and the rotational shaft body 1 can be perpendicularly connected. If a rotational shaft body of a driven body and the rotational shaft body 1 are coupled via a coupling, direct driving can be performed. With the direct driving, a drive system having good controllability with accuracy without backlash can be achieved.

According to the present exemplary embodiment, therefore, a vibration wave motor that is small and of a shaft output type can be provided.

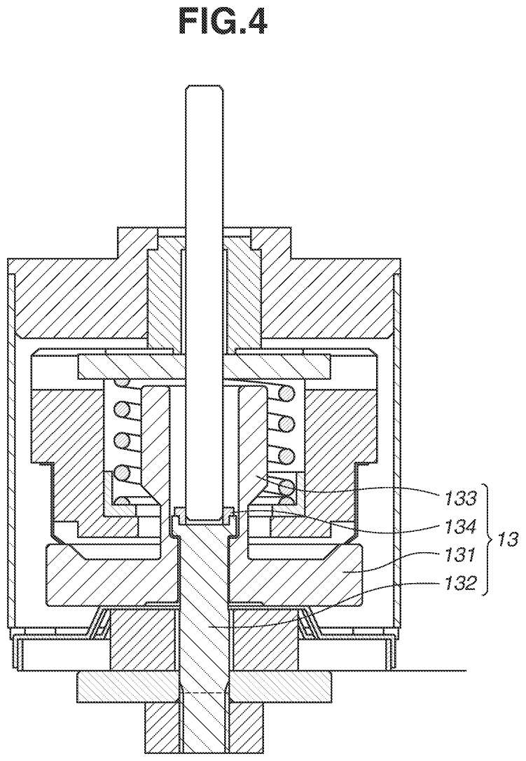

A second exemplary embodiment is described with reference to FIG. 4.

In FIG. 4, a second elastic portion that forms a first elastic body 13 is formed separately from a first elastic portion (and a third elastic portion) that forms the first elastic body 13. That is, internal components (including a piezoelectric element and a second elastic body) are held by a nut 51 and a shaft (the second elastic portion) 132 that is formed separately from a first elastic portion 131 (and a third elastic portion 133) and fitted into the first elastic portion 131.

Since the first elastic portion 131 is frictionally driven, the first elastic portion 131 is preferably made of a material having high abrasion resistance. In particular, if a vibration wave motor has high torque, the first elastic portion 131 is preferably made of a material such as SUS440C that is the hardest stainless steel from an abrasion resistance standpoint, Since SUS440C is hard, formation of the first elastic portion 131 and the second elastic portion 132 as separate portions can be less expensive than cutout of the first elastic portion 131 and the second elastic portion 132 as an integrated portion. Accordingly, in the present exemplary embodiment, the first elastic portion 131 (and the third elastic portion 133) is preferably made of SUS440C, and the second elastic portion 132 is preferably made of SUS420J2 or a material such as SUS420F and SUSU303, in consideration of a balance between workability and strength.

On an upper portion of the second elastic portion 132, a groove to which a first bearing portion 134 is provided is arranged, and the first bearing portion 134 is fixed to the groove. Since other functions of the second exemplary embodiment are similar those of the first exemplary embodiment, descriptions thereof are omitted.

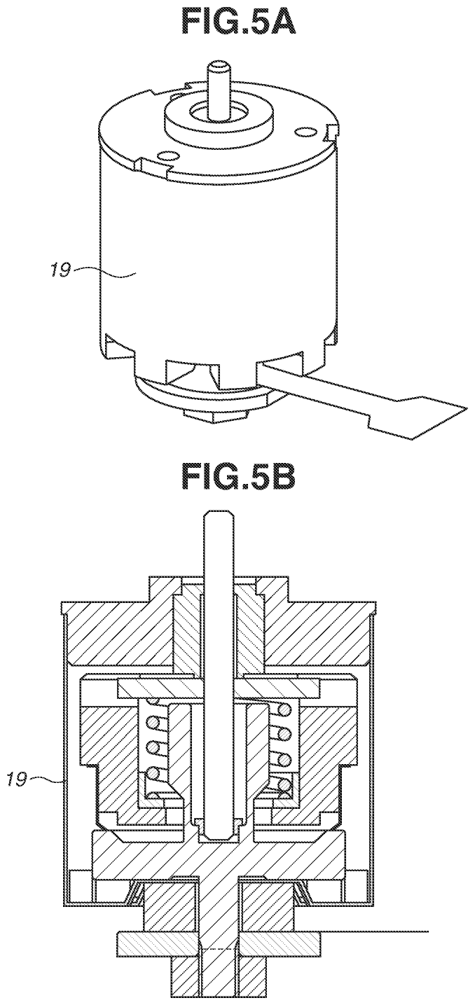

A third exemplary embodiment is described with reference to FIGS. 5A and 5B.

In the present exemplary embodiment, a first connection portion and a second connection portion are integrally formed, and a support case (a connection member) 19, which has a function of both of the first connection portion and the second connection portion, supports a vibrator 17. Similar to the first exemplary embodiment, a case support portion (a second connection portion) 92 having a plate shape is arranged between a first elastic portion 31 and a piezoelectric element 2, Eight legs extend from between the first elastic portion 31 and the piezoelectric element 2, The eight legs are bent and connected to a cylindrical portion. Accordingly, appropriate spring property is provided, and vibration of a vibrator 17 is not inhibited. The support case 19 is preferably manufactured by press work because of its shape.

With such integration, (similar to the first exemplary embodiment) processing for fixing the first connection portion to the second connection portion can be omitted, and the number of components is reduced. Therefore, a vibration wave motor can be manufactured at a lower cost.

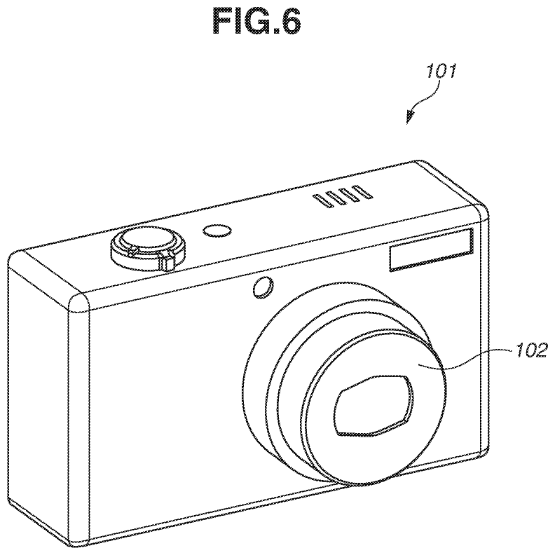

A fourth exemplary embodiment is described with reference to FIG. 6.

The present exemplary embodiment is described using an example in which the above-described vibration wave motor is installed in an image capturing apparatus as one example of an electronic device. FIG. 6 is a perspective diagram schematically illustrating a structure of a digital camera 101 as one example of an image capturing apparatus.

On the front surface of the digital camera 101, a lens barrel 102 is attached, A lens group (a driven body) (not illustrated) movable in an optical axis direction is arranged inside the lens barrel 102. The lens group can be driven by a vibration wave motor. Precisely, the vibration wave motor is driven by the driving method described in the first exemplary embodiment to drive the lens group arranged in the lens barrel 102 via a driving force transmission member (not illustrated). For example, the vibration wave motor can be optionally used for driving a zoom lens and/or a focus lens. The driven body is not limited to lens groups, and can be used in various apparatuses that are expected to be small and to have a high degree of freedom of output configuration.

As described in the first exemplary embodiment, the vibration wave motor which is small and of a shaft output type can be provided. Thus, for example, the vibration wave motor can be arranged perpendicular to an optical axis of an optical system in an image capturing apparatus, so that a thickness in the optical direction in the image capturing apparatus can be reduced.

According to each of the exemplary embodiments, a vibration wave motor that is not only small but also of a shaft output type, which has a higher degree of freedom of output configuration than a gear output type, can be achieved.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-113762, filed Jun. 14, 2018, which is hereby incorporated by reference herein in its entirety.

1. A vibration wave motor comprising:
a rotational shaft body;
an electrical-mechanical energy conversion element;
a first elastic body that is fitted into the rotational shaft body in an axially rotatable manner and configured to vibrate by the electrical-mechanical energy conversion element;
a driven member that is rotated about a rotation axis of the rotational shaft body by vibration of the first elastic body;
a fixing member configured to fix the rotational shaft body and the driven member;
a positioning member that is fitted into the rotational shaft body in an axially rotatable manner and configured to position the rotational shaft body in a rotation axis direction of the rotational shaft body; and
a connection member configured to connect the first elastic body to the positioning member.

2. The vibration wave motor according to claim 1,
wherein the first elastic body includes a first elastic portion that vibrates by the electrical-mechanical energy conversion element and has a flange shape in which a longitudinal direction is a second direction perpendicular to the rotation axis direction of the rotational shaft body, and a second elastic portion that protrudes from a first surface on a side of the electrical-mechanical energy conversion element in the first elastic portion and has a longitudinal direction that is the rotation axis direction of the rotational shaft body, and
wherein the second elastic portion is fitted into the electrical-mechanical energy conversion element and a second elastic body.

3. The vibration wave motor according to claim 2,
wherein the first elastic body includes a third elastic portion that is provided from a second surface at a side opposite the first surface in the first elastic portion, has a tube shape with a longitudinal direction that is the rotation axis direction of the rotational shaft body, and surrounds the rotational shaft body in a direction perpendicular to the rotation axis direction of the rotational shaft body, and
wherein the third elastic portion and the driven member overlap in the direction perpendicular to the rotation axis direction of the rotational shaft body.

4. The vibration wave motor according to claim 2, wherein the second elastic portion is integrally formed with the first elastic portion.

5. The vibration wave motor according to claim 2, wherein the second elastic portion is formed separately from the first elastic portion, and is fitted into the first elastic portion.

6. The vibration wave motor according to claim 1, wherein the rotational shaft body and the electrical-mechanical energy conversion element do not overlap in a direction perpendicular to the rotation axis direction of the rotational shaft body.

7. The vibration wave motor according to claim 1,
wherein the first elastic body includes a first bearing portion,
wherein the positioning member includes a second bearing portion, and
wherein the rotational shaft body is fitted into the first bearing portion and the second bearing portion.

8. The vibration wave motor according to claim 7, wherein the first elastic body includes the first bearing portion at a position including a node of vibration of the first elastic body.

9. The vibration wave motor according to 1, further comprising:
a second elastic body that is fitted into the first elastic body and sandwiches the electrical-mechanical energy conversion element together with the first elastic body; and
a fastening member configured to fasten the electrical-mechanical energy conversion element and the second elastic body to the first elastic body.

10. The vibration wave motor according to claim 9, wherein the fastening member includes a nut and an external thread that is formed on the first elastic body.

11. The vibration wave motor according to claim 10, wherein the second elastic body is integrally formed with the nut.

12. An apparatus comprising:
a vibration wave motor comprising:
a rotational shaft body;
an electrical-mechanical energy conversion element;
a first elastic body that is fitted into the rotational shaft body in an axially rotatable manner and configured to vibrate by the electrical-mechanical energy conversion element;
a driven member that is rotated about a rotation axis of the rotational shaft body by vibration of the first elastic body;
a fixing member configured to fix the rotational shaft body and the driven member;
a positioning member that is fitted into the rotational shaft body in an axially rotatable manner and configured to position the rotational shaft body in a rotation axis direction of the rotational shaft body; and
a connection member configured to connect the first elastic body to the positioning member; and
a driven body configured to be driven by the vibration wave motor.
